(19) United States
(12) Patent Application Publication
(10) Pub. No.: US 2004/0069146 A1
(43) Pub. Date: Apr. 15, 2004

(54) Adsorptive duct for contaminant removal, and methods

(76) Inventors: Steven Alan Carter, Eagan, MN (US); Jordan Spencer Flagstad, East Bethel, MN (US); Lefei Ding, Falcon Heights, MN (US); Jon Dennis Joriman, Little Canada, MN (US); Andrew James Dallas, Apple Valley, MN (US)

Correspondence Address: Mara E. Liepa, Merchant & Gould P.C., P.O. Box 2903, Minneapolis, MN, 55402-0903, US

(21) Appl. No.: 10/632,057

(22) Filed: Jul. 31, 2003

Related U.S. Application Data
(60) Provisional application No. 60/400,106, filed on Jul. 31, 2002.

(51) Int. Cl. B01D 53/02

(52) U.S. Cl. 96/108

(57) ABSTRACT

A duct for passage of air therethough; one particular use for the duct is as a passage for intake air for a vehicle engine. The duct has an interior, adsorptive region that is adapted to remove contaminants from the air stream passing therethrough. The adsorptive region includes adsorptive material such as carbon (usually activated carbon), activated alumina, zeolites, metal oxides or ion exchange resin. The duct inhibits diffusion of uncombusted gasoline back through the duct from the engine, after the engine has been shut off.

This application claims priority under 35 U.S.C. § 119(e) to U.S. provisional application serial No. 60/400,106 filed Jul. 31, 2002 and entitled “Adsorptive Duct and Methods”. The entire disclosure of No. 60/400,106 is incorporated by reference.

### FIELD

The present invention relates to an adsorption element for removing contaminants from a gaseous stream, such as an air stream.

### BACKGROUND

Gas adsorption articles or elements are used in many industries to remove airborne contaminants to protect people, the environment, and often, a critical manufacturing process or the products that are manufactured by the process. A specific example of an application for gas adsorption articles is the semiconductor industry where products are manufactured in an ultra-clean environment, commonly known in the industry as a “clean room”. Gas adsorption articles are also used in many non-industrial applications. For example, gas adsorption articles are often present in air movement systems in both commercial and residential buildings, for providing the inhabitants with cleaner breathing air.

Common airborne contaminants include basic contaminants such as ammonia, organic amines, and N-methyl-2-pyrrolidone, acidic contaminants such as hydrogen sulfide, hydrogen chloride, or sulfur dioxide, and general organic material contaminants, often referred to as VOCs (volatile organic compounds), such as reactive monomer or unreactive solvent. Reactive and unreactive silicon containing materials, such as silanes, siloxanes and silanols, can be particularly detrimental contaminants for some applications. Many toxic industrial chemicals and chemical warfare agents should be reoved for some use applications, and must be removed from breathing air.

What is needed is a contaminant removal system that can effectively remove contaminants such as acids, bases, or other organic materials from a fluid stream.

### SUMMARY OF THE INVENTION

The present invention is directed to an adsorptive item having a passage therethrough. In particular, the adsorptive item is a duct constructed for the passage of fluid, typically gaseous fluids, such as air, therethrough. The duct has an interior region adapted to remove contaminants from the air or other fluid stream by adsorbing, absorbing, trapping, retaining, reacting, or otherwise at least temporarily removing contaminants from the fluid stream. The region includes an adsorptive material, present on at least the surface of the adsorptive region. The adsorptive material traps or otherwise retains contaminants on its surface or in pores. The collected contaminants could be released or desorbed at a desired time, for example, by reactivating the adsorptive material. Various methods for reactivating the adsorptive material include increasing the air flow past the adsorptive region compared to the air flow when the adsorption occured, increasing the temperature of the region or air stream compared to when the adsorption occured, and applying or removing a current or a voltage to the region.

The adsorptive region or surface can be formed simultaneously with the base duct, or by subsequently applying an adsorptive material to the duct interior. Examples of suitable adsorptive material for the adsorptive region include carbon (usually activated carbon), alumina (usually activated alumina), zeolites, metal oxides and ion exchange resins. The adsorptive material is generally bound by a polymeric adhesive or resin into or to the base duct.

The adsorptive duct of the present invention can be used in any variety of applications in which the removal of chemical contaminants from a fluid stream (typically from a gaseous stream), such as an air stream, is desired. An adsorptive air duct of the present invention is suitable in any operation or application where chemical contaminants can escape into the environment and where it is desired to inhibit the escape of these contaminants. One example application for an adsorptive air duct of the present invention is in automobile fuel system or engine induction system. For such an application, the usual contaminants removed by the adsorptive duct include hydrocarbons and petrochemicals, such as gasoline and diesel fuel.

### BRIEF DESCRIPTION OF THE DRAWINGS

Referring now to the drawings, wherein like reference numerals and letters indicate corresponding structure throughout the several views:

FIG. 1 is a perspective view of an air duct according to the present invention;

FIG. 2 is a schematic, enlarged cross-sectional view of one embodiment of a portion of the air duct of FIG. 1;

FIG. 3 is a schematic, enlarged cross-sectional view of a second embodiment of a portion of the air duct of FIG. 1;

FIG. 4 is a schematic, enlarged cross-sectional view of a third embodiment of a portion of the air duct of FIG. 1; and

FIG. 5 is a schematic diagram of a system incorporating the air duct of FIG. 1.

### DETAILED DESCRIPTION

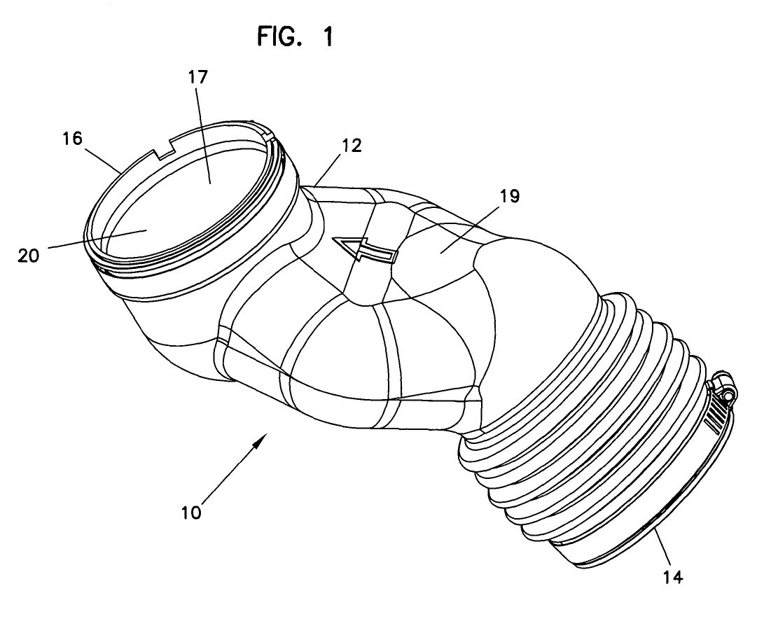

Referring now to the Figures, specifically to FIG. 1, an adsorptive element or article according to the present invention is shown at 10. Adsorptive element 10 is defined by a hollow body 12 having a first end 14, a second end 16, an inner surface 17 and an outer surface 19. Hollow body 12 is generally at least about 1 mm thick; additionally or alternatively, hollow body 12 is generally no thicker than about 1 cm. Typically, body 12 is about 3-5 mm thick. Adsorptive element 10 is constructed for passage of air or any other fluid therethrough. Inner surface 17 includes an adsorptive region 20.

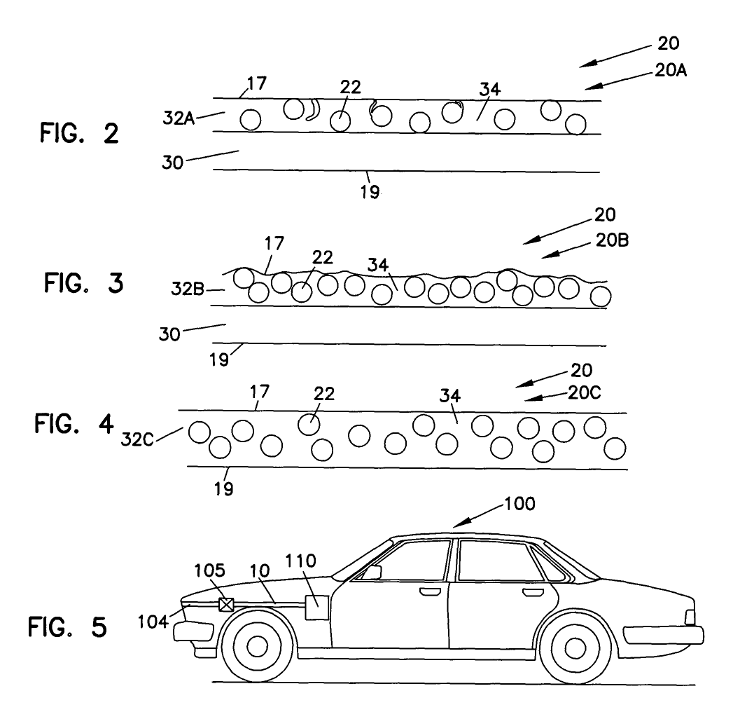

Adsorptive region 20 is constructed and arranged to remove a contaminant from the air or other fluid present in duct 10 by adsorbing the contaminant from the fluid stream. The term “adsorbing” and variations thereof are intended to cover any removal of a contaminant from the fluid stream, including adsorbing, absorbing, trapping, retaining, reacting, or otherwise at least temporarily removing the contaminant from the fluid stream. In some systems, it may be desired that a contaminant adsorbed by adsorptive region 20 is released or desorbed after a predetermined time period or at a desired time. Releasing or desorbing a contaminant can be accomplished by reactivating the adsorptive region or the material that provides the adsorptive properties to region 20. Methods for reactivating adsorptive region 20 include increasing the air flow past adsorptive region 20, compared to the air flow when the adsorption occurred, increasing the temperature of the region 20 or air stream, compared to when the adsorption occurred, and applying or removing a current or a voltage to region 20. Referring to FIGS. 2-4, various embodiments of adsorptive region 20 are illustrated.

Adsorptive region 20 includes an adsorptive material 22 present at or near inner surface 17 of duct 10. Adsorptive material 22 adsorbs or removes contaminants from the air or other fluid that contacts material 22. The term “adsorbs” and variations thereof are intended to cover any process that removes contaminants from the fluid stream, including adsorbing, absorbing, trapping, retaining, reacting, or otherwise at least temporarily removing the contaminants from the fluid stream. The contaminant may be physically bound to the surface or within pores of adsorptive material 22, or the contaminant may be chemically reacted with material 22. The size of the contaminants and the porosity of adsorptive material 22 may be such that contaminants enter into and become physically trapped within pores or passages within adsorptive material 22. Typically, however, the surfaces of the adsorptive material 22 chemically interact with the contaminants, thus adsorbing the contaminants at least on the surfaces of material 22. Material 22 can additionally or alternately be an oxidizing agent; oxidizing agents are materials that oxidize volatile organic compounds (VOCs) into carbon dioxide and water.

Examples of materials suitable as adsorptive material 22 include carbon (including activated carbon), activated alumina, zeolites, metal oxides, polymer particulates such as ion exchange resins, sodium bisulfate, getters, clays, silica gels, superacids and/or heteropolyacids. Adsorptive material 22 is usually present as a particulate, which includes spherical particles, semi-spherical particles, rods, regularly shaped particles, irregularly shaped particles, tubes, and the like. The particulate can be hollow or solid. Liquid oxidizing agents, in addition to or alternately to particulate oxidizing agents, can be used.

Typically, adsorptive material 22, when in the particulate form, has a tight particle size distribution; that is, the size of the particulates or particles does not vary greatly within the sample. Suitable sizes of generally spherical material 22 include 100 mesh (about 120-125 micrometers), 150 mesh (about 85 micrometers), 250 mesh (about 40 micrometers), and 400 mesh (about 20-25 micrometers). Suitable sizes of fibers or rods include diameters of about 20-50 micrometers and lengths of about 50-150 micrometers. The specific mesh size used will depend on the type of adsorptive material 22 used, and the construction by which it is present in region 20.

Examples of suitable activated carbons include 50-100 mesh activated carbon beads, 50-100 mesh activated carbon granules, and 325-400 mesh carbon powder. Carbon fibers can also be used. Examples of suitable ion exchange resins include Dowex® 50WX8-100 ion exchange resin, Dowex® 50WX8-200 ion exchange resin, Dowex® 50WX8-400 ion exchange resin, Dowex® Optipore V493, and Dowex® Optipore V503.

The concentration of adsorptive material 22 within adsorptive region 20, throughout the thickness of duct 10, from inner surface 17 to outer surface 19, is usually at least about 10% by weight. Additionally or alternatively, the concentration of adsorptive material 22 within adsorptive region 20, from inner surface 17 to outer surface 19, is no greater than about 95% by weight. The concentration should be sufficient to provide acceptable adsorptive properties to region 20 while maintaining the physical integrity of region 20. Typically, the concentration adsorptive material 22 from inner surface 17 to outer surface 19 is about 20-90% by weight. This may vary from the concentration of adsorptive material 22 at or exposed to surface 17, which is generally greater than about 20%, generally no greater than about 90%, and is typically about 40-80% of the surface area.

Various specific variations of adsorptive region 20 with adsorptive material 22 are illustrated as adsorptive regions 20A, 20B, and 20C in FIGS. 2, 3 and 4, respectively.

A First Embodiment

Illustrated in FIG. 2 is adsorptive region 20A, a portion of duct 10 which includes a plurality of adsorptive material particles 22. Adsorptive region 20A includes a base layer 30 and an adsorptive layer 32A, the adsorptive particles 22 being present within adsorptive layer 32A.

Base layer 30, which generally forms the overall structure of body 12 and defines outer surface 19, is formed from a polymeric material, such as polyethylene, polypropylene, polyvinyl chloride (PVC), polycarbonate, nylon, polystyrene, poly(methyl methacrylate), thermoplastic elastomers (TPE), and any combinations thereof. Reinforcing materials, such as scrim, fibers and the like may be present within base layer 30. The material used for base layer 30 should have a softening point of no less than about 275° F. Base layer 30 is substantially impermeable to components commonly found in air.

Adsorptive layer 32A, present adjacent to and attached to base layer 30, defines inner surface 17. Adsorptive layer 32A includes a plurality of adsorptive particles 22 distributed throughout a polymeric material 34, such as polyethylene, polypropylene, polyvinyl chloride (PVC), polycarbonate, nylon, polystyrene, poly(methyl methacrylate), thermoplastic elastomers (TPE), thermoplastic rubbers (TPR), and any combinations thereof. The material 34 used in adsorptive layer 32A should have a softening point of no less than about 275° F. The polymeric material 34 of layer 32A can be the same material as used for base layer 30.

Adsorptive layer 32A, in some embodiments, has a “microchanneled” texture, which allows contaminants to enter below the inner surface 17 of layer 32A and become trapped, at least temporarily. By the term “microchannel” and variations thereof, what is intended is openings, channels, pores, or passages, typically no greater than about 5 nm in diameter, preferably no greater than about 2 nm in diameter, within adsorptive layer 32A, generally in polymeric material 34, that extend from surface 17 into layer 32A. The porosity of adsorptive layer 32A is intrinsic to polymeric material 34 and adsorptive material 22, and can be modified by additives or by the processing of layer 32A. A microchanneled texture generally forms when additives to by polymeric material 34 have a substantially different melting point, usually at least about 50° F. different, than the primary component of layer 32A. The pores or channels may be interconnected or may be individual.

Duct 10 having adsorptive region 20A can be made by simultaneously forming base layer 30 and adsorptive region 20A. Layers in addition to base layer 30 and adsorptive region 20A can be included in duct 10; for example, a tie layer between base layer 30 and adsorptive region 20A can be included. Suitable methods for making duct 10 with adsorptive region 20A include various molding techniques and extrusion techniques. Preferred molding processes are blow molding and suction or vacuum blow molding. Suction or vacuum blow molding is well known in the art of molding for providing products with multiple layers. Injection molding, including reaction injection molding, may also be used.

When using molding techniques, the preferred size of adsorptive material 22 is about 100-325 mesh, and the concentration of material 22 in adsorptive layer 32A is about 20-90% by weight, more preferably about 40-80% by weight. The thickness of adsorptive layer 32A is preferably about 0.5-1 mm and the thickness of base layer 30 is preferably about 2-3 mm.

A Second Embodiment

Illustrated in FIG. 3 is adsorptive region 20B, a portion of duct 10 which includes a plurality of adsorptive material particles 22. Similar to adsorptive region 20A of FIG. 2, adsorptive region 20B includes base layer 30 and an adsorptive layer 32B adjacent base layer 30, the adsorptive particles 22 being present within adsorptive layer 32B. Base layer 30 has been described above.

Adsorptive layer 32B, adjacent to and attached to base layer 30, defines inner surface 17 and includes a plurality of adsorptive particles 22 distributed throughout polymeric material 34, which has been described above.

Duct 10 having adsorptive region 20B can be made by applying adsorptive layer 32B onto base layer 30 subsequent to base layer 30 being made. Base layer 30 can be made by any number of known techniques, including molding and extrusion. Adsorptive layer 20B is usually applied to base layer 30, for example, as a coatable liquid, mixture or slurry of polymeric material 34 and adsorptive particles 22, with polymeric material 34 being, for example, a solution, a dispersion, or a hot melt. If adsorptive layer 32B is formed from a melted mixture of polymeric material 34, such as a hot melt material, and adsorptive material 22, it is preferred that prior to melting, polymeric material 34 and adsorptive material 22 have the same, or a similar, particle size.

Examples of materials suitable as polymeric material 34 for a post-coating process include hydrophilic polymer adhesives such as poly(ethylene glycol) and poly(propylene glycol), poly(vinyl alcohol), polyvinylpyrrolidone, hydroxyethyl cellulose, hydroxypropyl cellulose, etc., and hydrophobic polymer adhesives such as cellulose acetate, ethyl cellulose, polysulfone, poly(2-hydroxyethyl methacrylate), poly(vinyl acetate), etc.

The coatable mixture or slurry can be applied by spraying, dipping, painting, extrusion, or otherwise coating base layer 30 with the mixture. It may be desired to provide a primer layer, etch, or otherwise modify the surface of base layer 30 prior to applying adsorptive layer 20B.

When using a post-coating process, the preferred size of adsorptive material 22 is about 100-325 mesh and the concentration, by weight, of material 22 in adsorptive layer 32B is about 50-95%, more preferably about 90%. The thickness of adsorptive layer 32B is about 1-2 mm and the thickness of base layer 30 is about 2-3 mm. Adsorptive layer 32B, in some embodiments, has a “microchanneled” texture, which allows contaminants to enter and become trapped below the inner surface 17 of layer 32B.

A Third Embodiment

Illustrated in FIG. 4 is adsorptive region 20C, a portion of duct 10 which includes a plurality of adsorptive material particles 22. Adsorptive region 20C has an adsorptive layer 32C having adsorptive particles 22 present therein. For this embodiment, no separate or discernible base layer is present. Rather, adsorptive layer 32C forms the overall structure of body 12, defines outer surface 19, and inner surface 17.

Duct 10 having adsorptive region 20C can be made by various molding techniques and extrusion techniques. When using molding techniques, the preferred size of adsorptive material 22 is about 100-325 mesh, and the concentration by weight of material 22 in adsorptive layer 32C is about 20-90%, more preferably about 30-60%. The overall thickness of adsorptive layer 32C is about 3-5 mm.

It is understood that other methods for forming adsorptive region 20 can be used. For example, particulate adsorptive material 22 could be electrostatically or drop coated onto a layer of adhesive on inner surface 17. As another example, heat adsorptive material 22, present at a temperature above the melting point of the material of duct body 12, could be impinged or otherwise applied to body 12; the high temperature of material 22 partially melting body 12 and adhering material 22 therein. Still another example would be to form base layer 30 and the adsorptive layer as a relatively flat sheet, and then form the flat sheet into duct 10, providing a passage for air or other fluid therethrough. The flat adsorptive layer could be made simultaneously or subsequent to flat base layer 30.

Adsorptive region 20 can have more than one adsorptive material 22 present; multiple materials can be mixed or be present separately in individual sections or regions. If present separately, a preferred configuration is to have the two materials positioned in series along the air flow path through duct 10. For example, adsorptive region 20 can have a first adsorptive material present closer to first end 14 and a second adsorptive material closer to second end 16. It is understood that other constructions and arrangements of elements with various materials, impregnants, and the like can be used.

In addition to or alternate to removing hydrocarbons, adsorptive region 20 can be constructed to remove airborne basic or acidic contaminant compounds, such as organic bases (for example, ammonia, amines, amides, N-methyl-1,2-pyrrolidone, sodium hydroxides, lithium hydroxides, potassium hydroxides), volatile organic bases, nonvolatile organic bases, airborne acidic compounds (for example, sulfur oxides, nitrogen oxides, hydrogen sulfide, hydrogen chloride), volatile organic acids and nonvolatile organic acids, and polar or non-polar organics. Adsorptive material 22 may be selected to adsorb or otherwise remove specific contaminants, or, additives may be added to modify the adsorptive properties of adsorptive material 22 or of any of adsorptive layers 32A, 32B, 32C. Examples of additives include ion exchange resins and impregnants, which can be impregnated into material 22, especially into carbon particulate. Examples of suitable impregnants are acids, bases, or catalysts.

Adsorptive region 20 may occupy the entire inner surface 17 of duct 10 or may occupy only a portion thereof. Region 20 occupies at least about 100 cm² of inner surface 17. Typically, region 20 is at least about 250 cm², preferably at least about 500 cm².

Applications for the Adsorptive Duct

Duct 10 of the present invention, made by any of the methods described above or by equivalent methods, is used for the removal of chemical contaminants from a fluid stream, such as an air stream. Examples of contaminants or active material that can be removed by duct 10 include any of hydrocarbons, petroleum products, VOCs, acidic contaminants, basic contaminants, organics, carbon monoxide and carbon dioxide, water, oxygen and ozone, nitrogen and hydrogen. One particular use for duct 10 is to remove gasoline or other petroleum vapors from an air stream.

Referring to FIG. 1 and in use, air, or other gaseous stream, enters duct 10 via first end 14, passes through body 12 coming into contact with inner surface 17 which includes adsorptive region 20, and then exits duct 10 via second end 16. It is understood that the adsorptive nature of duct 10 also exists when the air flow is in the reverse direction, from second end 16 to first end 14.

A duct such as illustrated in FIG. 1 can be used in an automobile, any other type of vehicle (such as a snowmobile, tractor, motorcycle, ATV, etc.), or any other engine or power generating equipment that uses an intake air source for the combustion process. Duct 10 can be used with any combustion process fueled by gasoline, diesel fuel, methanol, ethanol, propane, natural gas, or the like. For example, a vehicle 100 utilizing duct 10 is illustrated in FIG. 5. Vehicle 100 has an air intake 104 that is connected to a conventional particulate air filter 105. Cleaned air from filter 105 passes through duct 10 to engine 110.

After the engine is shut-off and the influx of air through intake 104, filter 105 and duct 10 is essentially halted, duct 10 inhibits the release of uncombusted gasoline vapors or other petrochemicals from the engine back to the atmosphere by absorbing the molecules on absorptive region 20. That is, vapors that may diffuse or otherwise travel to duct 10 from engine 110 are adsorbed by adsorptive region 20. When the engine is restarted, the incoming flow of fresh air preferably releases the vapors adsorbed or otherwise retained in adsorptive region 20 and returns the vapors to engine 110 for combustion.

During the time when the engine is not operating, the amount of gasoline vapors passing out from duct 10 is minimal; that is, duct 10 inhibits the passage of vapors therethrough by adsorbing the hydrocarbons and other materials onto adsorptive region 20. In one preferred design, duct 10 allows no more than 82 mg of gasoline vapor per 24 hours to pass through duct 10, when exposed to 1 gram of gasoline over a total of 73 hours. In a more preferred design, duct 10 allows no more than 82 mg of gasoline vapor per 24 hours therethrough, when exposed to 1.5 grams of gasoline over a total of 73 hours.

Duct 10 can also be used in an automobile or any other type of vehicle or other engine or power generating equipment that uses an intake air source for the power source, but not necessarily a combustion process. For example, duct 10 can be used with a process obtaining power from a fuel cell. Air, or another oxygen source, can be passed through duct 10 to remove contaminants that might be detrimental to the fuel cell catalytic process.

A suitable passageway size for duct 10, that is, the cross-section area of duct 10 taken generally parallel to first end 14 or second end 16, is greater than about 10 in² (about 65 cm²), no greater than about 50 in² (about 322 cm²), and is usually about 12 to 24 in² (about 77.5 to 155 cm²), although this is generally designated by the air flow desired for the operation of engine 110.

As mentioned above, adsorptive region 20 may occupy the entire inner surface 17 of duct 10 or may occupy only a portion thereof. Typically, region 20 is at least 250 cm², preferably at least 500 cm². The area of adsorptive region 20 can be designed to remove the desired amount of contaminants from the gas or air passing therethrough, based on the residence time of the gas in duct 10. For example, preferably at least 90%, more preferably at least 95% of contaminants are removed and adsorbed. In some constructions, as much as 98%, or more, of the contaminant is removed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed:

1. An adsorptive duct comprising:
(a) a hollow duct body having a first end, a second end and a passage extending therethrough from the first end to the second end, the passage having an inner exposed surface; and
(b) an adsorptive region present within the duct body, at least a portion of the adsorptive region defining the inner surface, the adsorptive region comprising an adsorptive material.

2. The adsorptive duct according to claim 1, wherein the adsorptive material comprises at least one of carbon, alumina, zeolites, metal oxides and ion exchange resin.

3. The adsorptive duct according to claim 2, wherein the adsorptive material is a particulate.

4. The adsorptive duct according to claim 1, wherein the adsorptive material occupies at least 10% by weight of the adsorptive region.

5. The adsorptive duct according to claim 4, wherein the adsorptive material occupies no more than 95% by weight of the adsorptive region.

6. The adsorptive duct according to claim 5, wherein the adsorptive material occupies 20-90% by weight of the adsorptive region.

7. The adsorptive duct according to claim 1, wherein the adsorptive material occupies about 40-80% of the surface area of the adsorptive region.

8. The adsorptive duct according to claim 1, wherein the duct body comprises an outer layer and an inner layer, the inner layer comprising the adsorptive region.

9. The adsorptive duct according to claim 1, wherein the duct body is made from a polymeric material comprising at least one of polyethylene, polypropylene, polyvinyl chloride, polycarbonate, nylon, polystyrene, poly(methyl methacrylate), and thermoplastic elastomer.

10. A method of making an adsorptive duct, the method comprising the steps of:
(a) forming a hollow duct body having an inner surface and defining a passage; and
(b) forming an adsorptive region comprising an adsorptive material, the inner surface of the duct body comprising at least a portion of the adsorptive region.

11. The method according to claim 10, wherein the step of forming the hollow duct body is done simultaneously with forming the adsorptive region.

12. The method according to claim 11, wherein the hollow duct body and the adsorptive region are blow molded or vacuum molded.

13. The method according to claim 12, wherein the hollow duct body and the adsorptive region are each formed as a layer.

14. The method according to claim 10, wherein the step of forming the hollow duct body is done before forming the adsorptive region.
